(19) United States
(12) Patent Application Publication
(10) Pub. No.: US 2016/0320779 A1
(43) Pub. Date: Nov. 3, 2016

(54) FLUID SUPPLY SYSTEM

(71) Applicant: GLOBAL AGRICULTURAL TECHNOLOGY AND ENGINEERING, LLC., Vero Beach, FL (US)

(72) Inventors: John R. Newton, Vero Beach, FL (US); Peter J. Brooke, Micco, FL (US)

(73) Assignee: GLOBAL AGRICULTURAL TECHNOLOGY AND ENGINEERING, LLC., Vero Beach, FL (US)

(21) Appl. No.: 15/108,674

(22) PCT Filed: Jan. 8, 2014
(86) PCT No.: PCT/US14/10611

§ 371 Date: Jun. 28, 2016

(51) Int. Cl. G05D 7/03

(52) U.S. Cl. CPC G05D 7/03

(57) ABSTRACT

According to the invention, a constant flow valve along with a three way control valve are arranged so as to provide an enhanced shut-off function. During closure of the flow valve, the pressure of the supply fluid is employed in a manner bolstering the valve's spring closure force, thereby resisting any tendency of the valve to open in response to fluid supply pressure surges above the valve's threshold opening level.

### BACKGROUND

1. Field of the Invention

This invention relates to fluidic systems employing constant flow valves that are normally closed, that are opened by fluid supply pressures above selected threshold levels, and that when open, serve to deliver fluids at a substantially constant pressure and flow rate.

2. Description of Related Art

Constant flow valves of the above-mentioned type are known, as evidenced for example by U.S. Pat. Nos. 6,026,850; 6,209,578; 7,445,021; and 7,617,839, the disclosures of which are herein incorporated by reference.

With reference to FIG. 3, a constant flow valve CFV of the type incorporated into fluidic systems of the present invention comprises a housing 10 having an internal flow path 12 leading from an inlet 14 to an outlet 16 equipped typically with a nozzle 18. A modulating assembly 20 includes a central hub 22 supported by a flexible diaphragm 24 isolating the flow path 12 from a chamber 26 containing a biasing means which typically may comprise a spring 28. A pin 30 projects from the central hub 22 through a port 32 in an internal housing wall 34. The spring 28 serves to resiliently urge the modulating assembly 20 into a normally closed position in which the diaphragm 24 is pressed against a circular shoulder 35 of the housing wall 34 to prevent fluid flow along the flow path 12 from the inlet 14 to the outlet 16. At inlet fluid pressures above a threshold level, the spring 28 is designed to yield and to accommodate movement of the modulating assembly and its diaphragm away from the circular shoulder 35 to an open position (as depicted in FIG. 3), at which the pin 30 and its enlarged head then coact with the port 32 to control and maintain a substantially constant pressure and flow rate of the fluid flowing along the flow path 12 from the inlet 14 to and out through the nozzle 18 at the outlet 16. A port 36 is provided at the bottom of the housing for a purpose to be described hereinafter.

In conventional fluidic systems, one example of which is depicted in FIGS. 4A and 4B, a shut-off valve V₁ is sometimes employed to control the on-and-off supply of fluid via a supply conduit 38 to a downstream constant flow valve CFV. As discussed above, the constant flow valve is normally closed by the spring 28, which is designed to yield to fluid supply pressures above a threshold level. At fluid supply pressures above the threshold level, and as depicted in FIG. 4B, the valve's modulating assembly 20 operates in its intended controlling mode to supply fluid to a discharge conduit 40 at a substantially constant pressure and flow rate.

Experience has shown, however, that even when the shut-off valve V₁ is closed, leakage through the constant flow valve CFV may occur if, for whatever reason, the fluid pressure in the supply conduit 38 surges to a level above the constant flow valve's threshold opening level. Such surges may occur, for example, when the system is being employed to dispense a carbonated liquid beverage component. Between dispensing cycles, the carbonating gas may come out of solution in the liquid trapped in the supply conduit 38 between the shut-off valve V₁ and the constant flow valve CFV, thereby producing a pressure increase of sufficient magnitude to overcome the closure force of spring 28, causing momentary leakage.

### SUMMARY OF THE INVENTION

In accordance with the present invention, the constant flow valve additionally provides a shut-off function. During valve closure, the fluid supply pressure is employed in a manner bolstering the valve's spring closure force, thereby resisting any tendency of the valve to open in response to fluid supply pressure surges above the valve's opening threshold level.

These and other features and attendant advantages of the present invention will now be described in further detail with reference to the accompanying drawings, wherein:

### BRIEF DESCRIPTION OF THE DRAWINGS

FIGS. 1A-1C are schematic illustrations of a fluidic system in accordance with one illustrative embodiment of the present invention, showing sequential stages of its operation;

FIGS. 2A-2C are schematic illustrations of a fluidic system in accordance with a second illustrative embodiment of the present invention, again showing sequential stages of its operation;

FIG. 3 is an illustration of a known constant flow valve CFV; and

FIGS. 4A and 4B are schematic illustrations of a conventional fluidic system susceptible to potential leakage problems.

### DETAILED DESCRIPTION

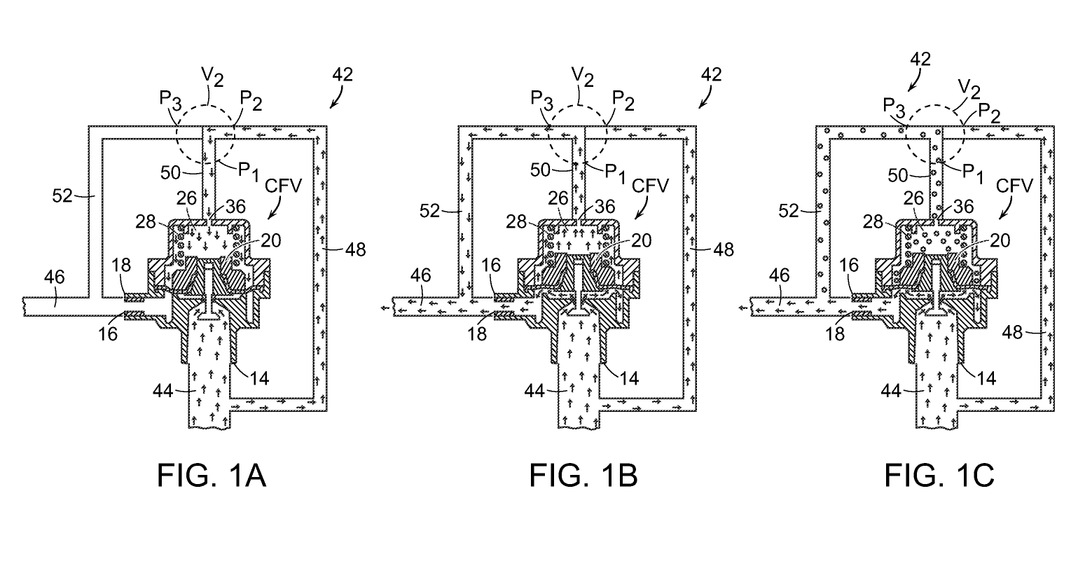

With reference to FIGS. 1A-1C, a fluidic system in accordance with one illustrative embodiment of the present invention is generally depicted at 42. The system is designed to receive a fluid via a supply conduit 44 at a variable pressure, and to deliver the fluid to atmosphere at a substantially constant pressure and flow rate via a discharge conduit 46. The system 42 is particularly suited for, although not limited in use to, the delivery of carbonated liquid beverage components.

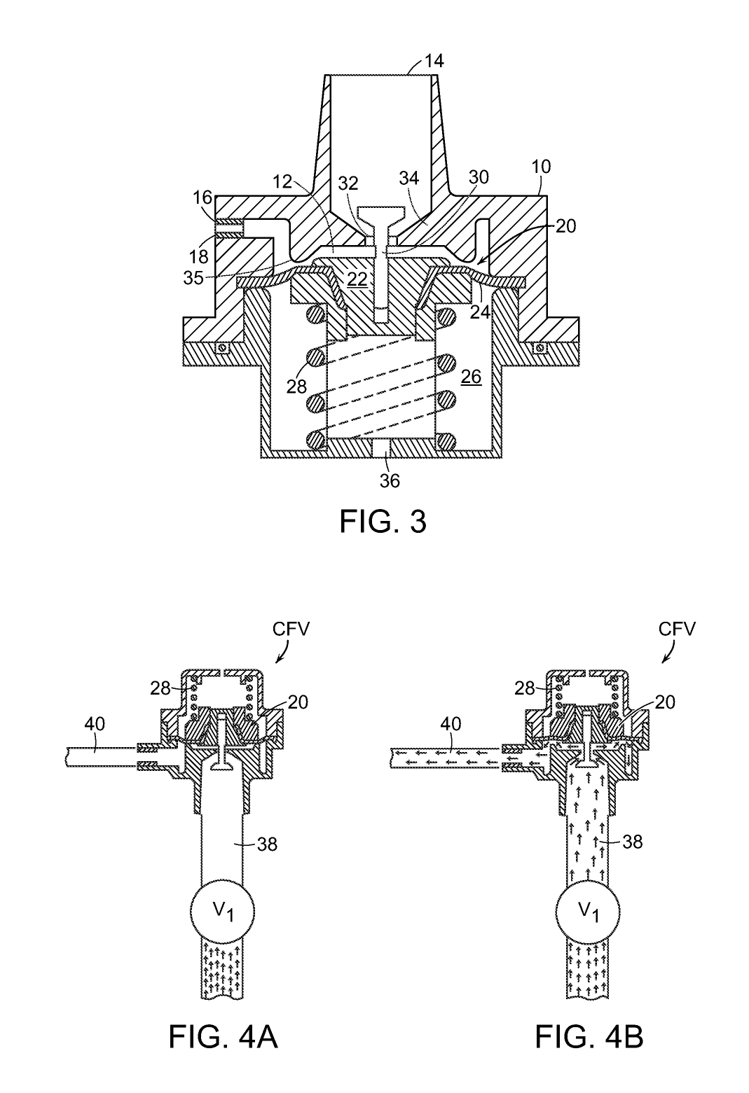

The system 42 comprises a constant flow valve CFV of the type illustrated in FIG. 3.

As shown in FIG. 1A, the spring 28 of the constant flow valve CFV serves to urge the modulating assembly 20 into its normally closed position preventing fluid flow through the valve from the supply conduit 44 to the discharge conduit 46.

A second valve V₂, which may for example comprise a three-way toggle valve of known design, has first, second and third ports P₁, P₂, P₃ connected respectively to the chamber 26 of the constant flow valve CFV, the supply conduit 44, and the discharge conduit 46. The valve V₂ may either be manually operated, or operated by a solenoid that may be energized remotely.

In the condition shown in FIG. 1A, the ports P₁ and P₂ of valve V₂ are open, and port P₃ is closed. A bypass conduit 48 serves to direct pressurized fluid from supply conduit 44 through ports P₂ and P₁ and a connecting conduit 50 into valve chamber 26 via port 36. The pressurized fluid admitted into chamber 26 serves to bolster the closure force of spring 28. Thus, in the event of a pressure surge in supply conduit 44, the same pressure surge will exert an added closure force on the modulating assembly 20, in effect counterbalancing any tendency of the modulating assembly to be displaced from its closed position, and insuring that the constant flow valve CFV remains shut.

In order to open the constant flow valve CFV, and as depicted in FIG. 1B, the valve V₂ is adjusted to close port P₂ and open port P₃ while port P₁ remains open. Fluid pressure in chamber 26 is thus relieved by bleeding fluid through port 36 via connecting conduit 50, valve ports P₁, P₃ and a second bypass conduit 52 leading to the discharge conduit 46. Thereafter, as depicted in FIG. 1C, movement of the modulating assembly 20 will be accommodated resiliently by spring 28 to control the flow and pressure of the fluid being dispensed to atmosphere via the discharge conduit 46.

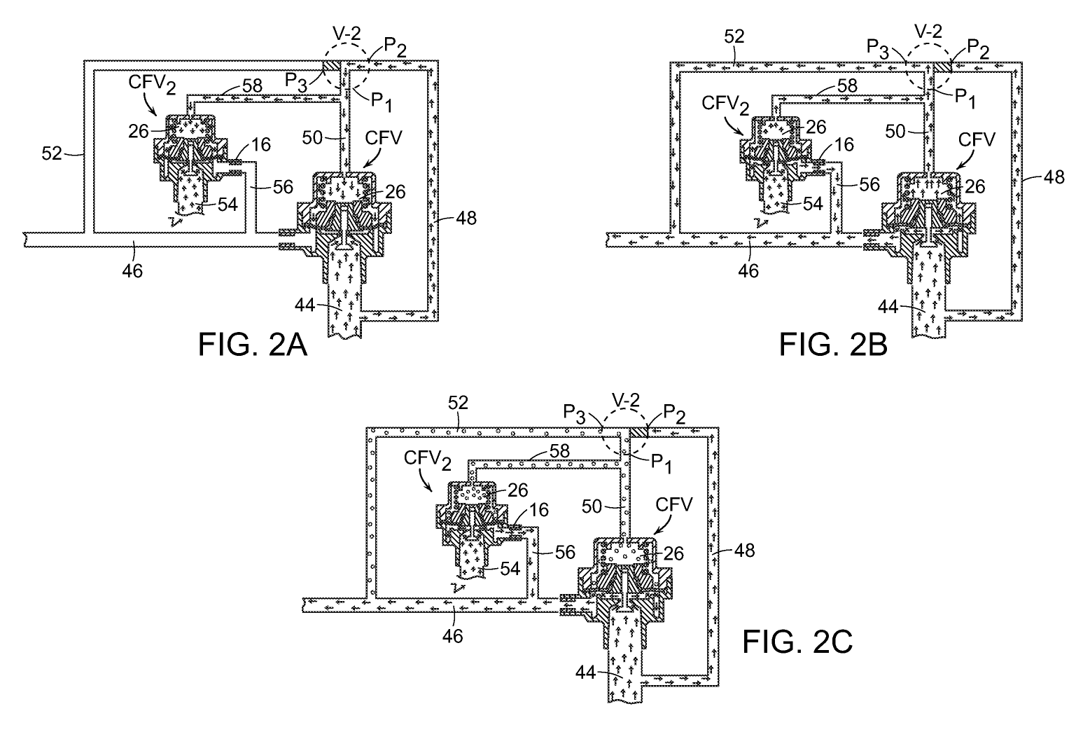

A fluidic system in accordance with a second illustrative embodiment of the present invention is depicted in FIGS. 2A-2C. Here, a second constant flow valve CFV₂ is incorporated into the fluidic system of FIGS. 1A-1C and serves to supply a controlled flow of a second fluid, which may for example comprise a liquid flavor concentrate to be combined with a carbonated liquid being supplied via constant flow valve CFV.

The second fluid is supplied to constant flow valve CFV₂ via a second supply conduit 54 from a remote source at variable pressures produced by a pump or the like (not shown). The outlet 16 of constant flow valve CFV₂ is connected by branch conduit 56 to the discharge conduit 46, and another branch conduit 58 connects the chamber 26 of constant flow valve CFV₂ to the conduit 50.

In FIG. 2A, both constant flow valves CFV and CFV₂ are closed, and closure is assured by the application of fluid pressure from supply conduit 44 to the chamber 26 of constant flow valve CFV via bypass conduit 48, ports P₂ and P₁ of control valve V₂ and connecting conduit 50, and to the chamber 26 of constant flow valve CFV₂ via branch conduit 58.

As shown in FIG. 2B, fluid pressure in the chambers 26 of both constant flow valves CFV and CFV₂ is relieved by closing port P₂ of control valve V₂ and opening port P₃ while allowing port P₁ to remain open. This allows fluid to be bled from the chamber 26 of constant flow valve CFV via conduits 50 and 52 to discharge conduit 46, and from the chamber 26 of constant flow valve CFV₂ via conduits 58, 50 and 52 to the discharge conduit 46.

Once fluid pressure is relieved in the chambers 26 of both constant flow valves, and as depicted in FIG. 2C, the constant flow valves then operate in their intended controlling mode to deliver the first and second fluids via the discharge conduit 46 at substantially constant pressures and flow rates.

It will be seen, therefore, that in each of the above described system embodiments of the present invention the constant flow valves provide a shut-off function in addition to flow and pressure control functions, with valve closures being immune from disturbance by pressure surges in the fluids being supplied to the valves.

By employing simple and relatively inexpensive control valves, e.g., three way toggle valves or the like, to selectively apply fluid supply pressures to open and close the constant flow valves, the need for more expensive upstream shut-off valves is eliminated, making it possible to reduce overall system costs.

We claim:

1. A system for receiving a fluid via a supply conduit at a variable pressure and for delivering said fluid to atmosphere via a discharge conduit at a substantially constant pressure and flow rate, said system comprising:
a constant flow valve having an internal flow path leading from an inlet to an outlet, said inlet being connected to said supply conduit, and said outlet being connected to said discharge conduit, a modulating assembly isolating said flow path from a chamber, and a biasing means in said chamber for resiliently urging said modulating assembly into a closed position preventing fluid flow along said flow path at pressures in said supply conduit below a threshold level, said biasing means serving to resiliently accommodate modulating movement of said modulating assembly at fluid pressures in said supply conduit above said threshold level; and
a control valve having a first port connected to said chamber, a second port connected to said supply conduit, and a third port connected to said discharge conduit, said control valve being adjustable between: a first condition at which said first and second ports are open to admit pressurized fluid from said supply conduit into said chamber, and said third port is closed to isolate said chamber from said discharge conduit, with the fluid pressure in said chamber thus being equal to the fluid pressure in said supply conduit, thereby insuring that the modulating assembly remains closed at fluid pressures in said supply conduit above said threshold level; and a second condition at which said second port is closed to isolate said chamber from said supply conduit and said first and third ports are open to connect said chamber to said discharge conduit, thereby relieving the fluid pressure in said chamber and allowing movement of the modulating assembly to be resisted solely to the closure force of said biasing means.

2. A system for receiving first and second fluids via first and second supply conduits at variable pressures and for delivering said fluids to atmosphere via a discharge conduit at a substantially constant pressure and flow rate, said system comprising:
a first constant flow valve having a first internal flow path leading from a first inlet to a first outlet, said first inlet being connected to said first supply conduit, and said outlet being connected to said discharge conduit, a first modulating assembly isolating said first internal flow path from a first chamber, and a biasing means in said first chamber for resiliently urging said first modulating assembly into a closed position preventing flow of said first fluid along said first flow path at pressures in said first supply conduit below a threshold level, said biasing means serving to resiliently accommodate modulating movement of said first modulating assembly at fluid pressures in said first supply conduit above said threshold level;
a second constant flow valve having a second internal flow path leading from a second inlet to a second outlet, said second inlet being connected to said second supply conduit, and said second outlet being connected to said discharge conduit, a second modulating assembly isolating said second flow path from a second chamber, and a biasing means in said second chamber for resiliently urging said second modulating assembly into a closed position preventing fluid flow along said second flow path at pressures in said second supply conduit below a threshold level, said biasing means serving to resiliently accommodate modulating movement of said second modulating assembly at fluid pressures in said second supply conduit above said threshold level; and
a control valve having a first port connected to said first and second chambers, a second port connected to said first supply conduit, and a third port connected to said discharge conduit, said control valve being adjustable between: a first condition at which said first and second ports are open to admit pressurized fluid from said first supply conduit into said first and second chambers, and said third port is closed to isolate said chambers from said discharge conduit, the fluid pressure in said first and second chambers thus being equal to the fluid pressure in said first supply conduit, thereby insuring that the first and second modulating assemblies remain closed at fluid pressures in said first supply conduit above the threshold levels of said first and second control valves; and a second condition at which said second port is closed to isolate said first and second chamber from said first supply conduit and said first and third ports are open to connect said first and second chambers to said discharge conduit, thereby relieving the fluid pressure in said first and second chambers and allowing the said first and second modulating assemblies to react solely to the closure forces of said biasing means.

3. The system of claim 2, wherein said first fluid is a carbonated liquid and said second fluid is a liquid additive.
